(19) United States
(12) Patent Application Publication
(10) Pub. No.: US 2012/0153028 A1
(43) Pub. Date: Jun. 21, 2012

(54) Transaction Card with dynamic CVV

(76) Inventors: Amir Poznansky, Tel Aviv (IL); Asher Yahalom, Givaat Shmuel (IL)

(21) Appl. No.: 13/326,397

(22) Filed: Dec. 15, 2011

Related U.S. Application Data
(60) Provisional application No. 61/423,122, filed on Dec. 15, 2010.

(51) Int. Cl. G06K 19/073

(52) U.S. Cl. 235/492

(57) ABSTRACT

The transaction card of the invention comprises a Card Verification Value (CVV) generator unit that generates a new CVV code each time the card user is invited to enter his CVV code, typically in a remote transaction. The CVV code is displayed on a screen on the transaction card. The screen can be a liquid crystal display (LCD) screen or any similar or newer display technology.

### CROSS REFERENCE TO OTHER APPLICATIONS

The present invention claims priority from U.S. Provisional Patent Application No. 61/423,122 filed on Dec. 15, 2011 and incorporated herein by reference.

### TECHNICAL FIELD

The present invention relates to transaction cards in general and in particular to transaction cards with improved security features such as a dynamic Card Verification Value (CVV) code generator.

### BACKGROUND ART

Magnetic cards, and in particular commercial credit cards, have been in use in commerce for over 50 years. Transactions cards are a very popular mean in order to identify a person or an account. Transaction cards are used for a variety of applications from financial transactions to registering presence to library cards. Financial transactions in the form of credit cards are probably one of the most popular uses of transactions cards today. These financial transactions include debit and credit card (which will be both referenced herein as “credit cards”), which are typically used for retail purchases, online purchases and cash retrieval at Automatic Teller Machines (ATM's).

Financial transactions via credit cards are very popular since they offer several advantages for both users and merchants. Users do not need to carry large amounts of cash on them in order to purchase goods or services. In addition, some cards offer the user, the possibility of deferring some or all of the payments for the goods or services purchased thus offering accessible (though not always cheap) credit services.

Credit cards offer several advantages to merchants, for example, not holding or accumulating large amounts of cash in the business (cash that can be lost, stolen, robbed and that needs secured delivery for deposit), guarantee of payments by the card issuer as opposed to personal checks that may not be honored. In addition, credit cards are an excellent tool to accept payment remotely from a user either on the Internet or over the telephone.

As credit cards become such a popular tool for payment, fighting credit card fraud has become a major issue for financial institutions and merchants. Credit card frauds can be categorized into two types of fraud: one where a genuine card is stolen or lost and arrives to the hands of an unauthorized user; the other type being when the information regarding a credit card arrives to an unauthorized user which uses this data to purchase goods or services online or alternatively manages to manufacture a duplicate credit card which is then used in retail and cash retrieval.

More and more credit card transactions are performed nowadays remotely either over the Internet, telephone, fax or mail or any online service. These types of transactions are known as “card not present (CNP) transactions” wherein the merchant does not see the actual credit card. The PIN code of the credit card is never used or requested in these remote transactions.

In order to improve the security of credit card retail transactions an additional 3 or 4 digit number known as Card Security Code (CSC) has been introduced and written on the card or signature stripe. The code known as CVC1 or CVV1 is intended for transactions in person and is encoded on the magnetic stripe. In contrary, other types of CSC are not encoded on the magnetic stripe and are used for remote transactions such as over the telephone, Internet, by mail or by fax or any other remote method. Those types of CSC are also known as Card Verification Value (CVV or CVV2), Card Verification Value Code (CVVC), Card Verification Code (CVC), Verification Code (V-Code or V Code), or Card Code Verification (CCV). Supplying the CSC code in a transaction is intended to verify that the customer has the card in his possession. Knowledge of the code proves that the customer has seen the card, or has seen a record made by somebody who saw the card.

One great concern is that the CVV number can fall into an unauthorized user who either has seen the card or has processed a legitimate transaction of the card. This unauthorized user can thus present this CVV in remote, fraudulent transactions.

There is thus an ongoing need, with great financial implications, to provide credit cards that include improved security features for CNP transactions.

### SUMMARY OF INVENTION

It is an object of the present invention to present a transaction card enabling to generate a new CVV code for each transaction.

The present invention thus relates to the protection of transaction cards in general and in particular to the protection of remote credit card transactions. The transaction card of the invention offers several levels of protection to make the transaction card more secure to own and use.

If a fraudulent user obtains a credit card (of the art) number including its (static) CVV code in an unauthorized way, the fraudulent user will be able to use the card in CNP transactions. The transaction card of the invention intends to combat such possibility by having the transaction card generate a new CVV code for each transaction. In this way, even if a fraudulent user obtains a credit card number, expiration date and CVV code, he will not be able to use the last CVV code in new transactions since any CVV code generated by the credit card of the invention is only valid for a single transaction (or alternatively only valid for a short period of time).

The transaction card of the invention comprises a CVV generator unit that generates a new CVV code each time the card user is invited to enter his CVV code, typically in a remote transaction. The CVV code is displayed on a screen on the transaction card. The screen can be a liquid crystal display (LCD) screen or any similar or newer display technology.

In addition, the transaction card of the invention can have an additional security measure by including an authentication unit that requests the card holder to authenticate himself before a new CVV code can be generated. In this way, if the transaction card is lost or stolen, anyone in possession of the transaction card cannot generate a new CVV code without authenticating himself as the legitimate card owner.

The authentication of the transaction card owner can be made in multiple ways, for example, by entering a PIN code via a keyboard on the card, via voice recognition authentication, via biometric authentication, using connection to a remote device such as a mobile phone, via any other known authentication processes or any combination there of.

Once the legitimate card owner authenticates himself, the transaction card's processor chip is activated for a predefined legitimate duration in which commercial CNP activities may take place. The defined legitimate time can be defined for one or more commercial transactions and/or for a limiting period of time. For example, after authentication the card can be defined as available for a single commercial transaction in the next 3 minutes; or for a single commercial transaction without any time limit; or for unlimited transactions in the next two minutes etc. These legitimate usage definitions and limits are typically defined by the transaction card issuer, though in principle they could also be set by the card owner.

During the legitimate time the CVV generator unit will generate a new CVV code synchronized with a real time clock which is installed in the processor hardware. The CVV number generated is different for each time interval. The algorithm can use a secret code (or a plurality of secret codes) and the time reading, to generate a different CVV code for each duration.

The dynamic CVV will be generated by multiplying the time reading by the card number ID (usually 16 decimal digits embossed on the front side of the card) and by multiplying the product by a public key which is usually a large prime number. The result will be a huge number of which twelve of the binary digits can be used as a dynamic CVV which contains three decimal digits. The method of choosing the CVV digits can rely on a private key such as the static CVV or a random number that will be assigned to the card during the manufacturing process, or using the time reading.

The clearing machine (or clearing software) will have possession of the time reading, the card ID number and the private and public keys and thus will be able to verify the dynamic CVV by regenerating the same, using the same method. One does not need to store a cartridge or a stack or a data base of CVV numbers in any form.

In a CNP transaction, the vendor or the clearing software transmits the CVV code that has been received from the customer to the clearing institution in a similar way to financial transactions with credit cards of the art. The clearing institution will verify the authenticity of the CVV code and will either approve or decline the financial transaction. The clearing institution compares the CVV code transmitted by the vendor to a CVV code generated internally, using similar methods to the CVV generator unit on the transaction card.

The present invention thus relates to a transaction card, comprising:
An identifying number associated with the transaction card;
A real-time clock;
A screen; and
A CVV generator unit that is based on said identifying number and based on the time reading of said real-time clock, produces a CVV code, said CVV code being displayed on said screen.

In some embodiments of the present invention, the identifying number is unique for each transaction card and assigned to it during manufacturing.

In some embodiments of the present invention, the identifying number is a random number.

In some embodiments of the present invention, the identifying number is the static CVV.

In some embodiments of the present invention, a newly generated CVV code is only valid for a single transaction.

In some embodiments of the present invention, a newly generated CVV code is only valid for a limited, predefined amount of time after the CVV code has been generated.

In some embodiments of the present invention, the CVV generator produces a CVV code by multiplying the identifying number by a number related to the time read from the real-time clock and by a big random number (a public key) as to obtain a very large number, wherein certain predefined bits are extracted from said very large number in order to form a CVV code.

In some embodiments of the present invention, the predefined bits are extracted for the Least Significant Bits (LSB).

In some embodiments of the present invention, the transaction card further comprising an authentication unit that authenticates the transaction card holder by requesting and authenticating a PIN code, said PIN code being entered via a keyboard, a keypad, voice recognition identification, biometric identification, identification via a connection to a remote device (such as a cellular phone) or any combination thereof.

In some embodiments of the present invention, a communication channel defined by International Organization for Standardization (ISO) 7816 is disabled until said authentication unit authenticates the transaction card holder.

In some embodiments of the present invention, disabling the 7816 communication channel is achieved by using the Mosfet gate to enable and disable the power pin of the 7816 connector.

In some embodiments of the present invention, the 7816 communication channel can be used to regenerate a new “random number” in case the previous “random number” has been disclosed.

In some embodiments of the present invention, a newly generated CVV code is valid for a single transaction or for a limited period of time or both.

### BRIEF DESCRIPTION OF DRAWINGS

FIG. 1 is an illustration of an embodiment of a transaction card of the present invention comprising a power source, a secure microprocessor chip, with a self Erasable Programmable Read Only Memory (EPROM), NFC communication chip, two status Light Emitting Diodes (LED), a Liquid Crystal Display (LCD), rechargeable battery, 7816 connector and a keypad.

FIGS. 2A and 2B shows an embodiment of a credit card according to the invention. FIG. 2A shows the front side of a credit card comprising of 7816 connector and the embossed numbers 230 representing the card ID.

FIG. 2B—show the back side of the credit card comprising of a LCD screen, two status LEDs and a numeric keypad with dynamic LCD touch keys in which the numbers are shown in a new position each time. The CVV code is given by 3-4 digits.

FIG. 3 is the schematic drawing of a transaction card of the invention, showing the main components of the transaction card of the invention.

FIG. 4 is a logical flowchart of the authentication process according to the invention.

FIG. 5 illustrates the CVV generator diagram.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to the protection of transaction cards such as credit cards, personal identification cards etc. For clarity purposes, the term “credit card” or “card” as used herein should be interpreted to include any type of transaction card.

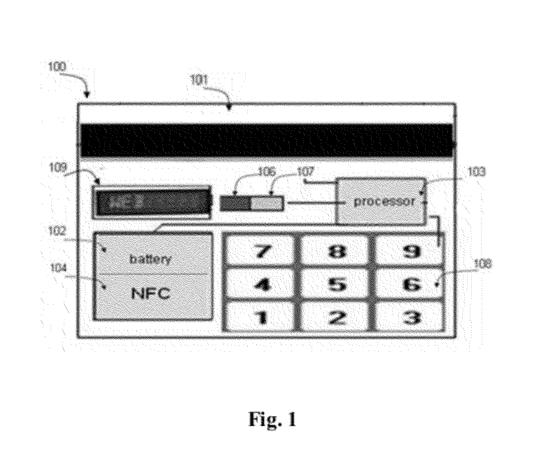

Reference is now made to FIG. 1 illustrating an embodiment of the transaction card 100 of the present invention; the transaction card is formed from a laminar plastic 101, typically having dimensions as specified in the ISO/TC97/SC17/WG4-N95. The card 100 comprises an independent power source 102 such as one based on “leaf battery”, a microprocessor chip 103 which contains a self EPROM memory, optionally a Near Field Communication (NFC) communication chip 104, two Light Emitting Diodes (LED) red 106 and green 107, a numeric keypad 108, and a display such as a 7 segment LCD 109. The two LED's, for example, green 107 and red 106 indicate the transaction card's state: green 107 for unlocked (approval) mode (open to perform a transaction) and red 106 for locked (card cannot perform any transaction). The 7 segment LCD 109 serves for displaying the typed authentication key (PIN) by the user and the dynamic CVV.

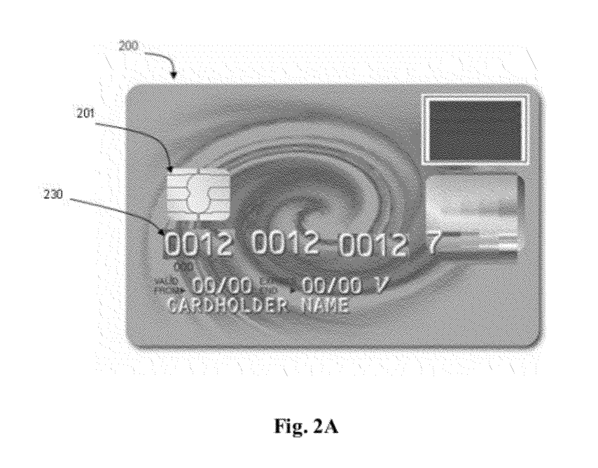

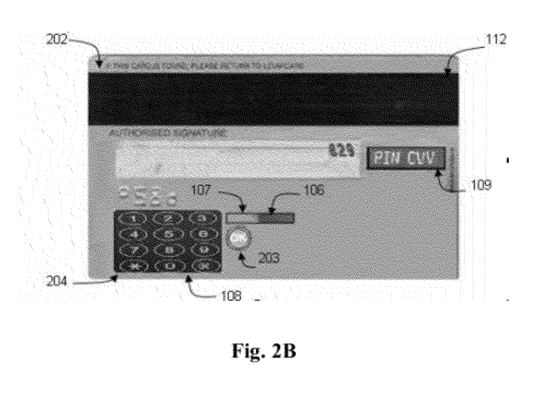

Reference is now made to FIGS. 2A-2B showing an embodiment of a credit card according to the invention. FIG. 2A shows the front side 200 of a credit card comprising the ISO 7816 connectors 201 that serve for communicating with the processor 103 of a transaction card, and the embossed numbers 230 representing the card ID. FIG. 2B show the back side 202 of the credit card 100 comprising a LCD screen 109 for displaying the CVV code, two status LED's 106, 107, an OK button 203 and a numeric keypad 108 with changing dynamic keys. When the user completes typing the PIN code digits correctly, the user presses the OK 203 button in order to load PIN code digits.

The GREEN LED 107 switches on in order to signal that the PIN code has been entered correctly and that the transaction card 100 is open to perform a transaction. The RED LED 106 switches on in case of a fraud usage detected or in case of an incorrect PIN code entered. The LCD display 109 shows the typed code. While the card is unlocked, the LCD will show the new CVV code for the next operation duration.

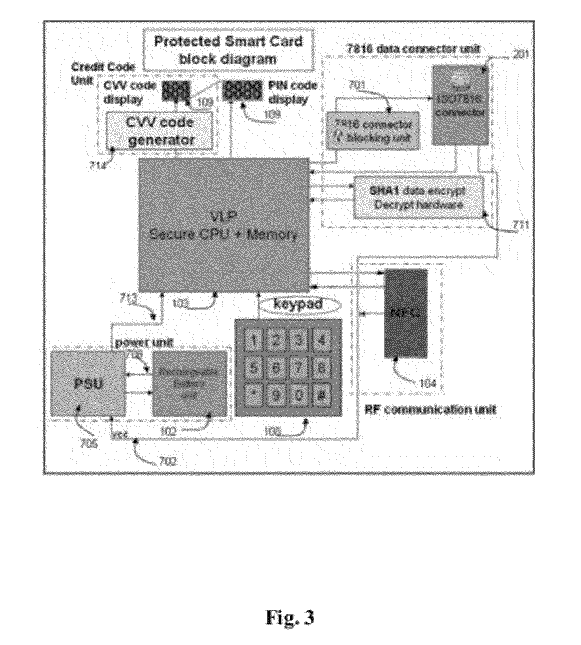

Reference is now made to FIG. 3. FIG. 3 illustrates the main components of the transaction card 100 of the invention: A CPU 103 and a memory for applying the CVV generation algorithms; A Power Supply Unit 705 including a rechargeable battery 102 that can be charged using the ISO 7816 connectors 201 through the connection 702; A keypad 108, supplied in order to activate the card 100 using a PIN code. Alternatively the PIN code can be entered using a cellular phone remote control through the NFC (Near Field Communication) unit 104; and a SHA1 (Secure Hash Algorithm) 711 data encryption hardware for secure communications of encrypted data.

### The Functional Operation

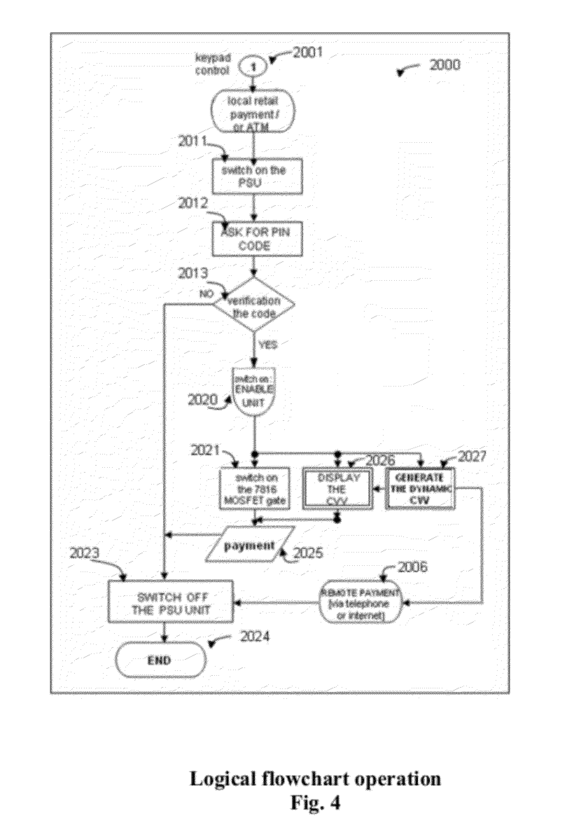

Reference is now made to FIG. 4. FIG. 4 illustrates the logical operation of the transaction card 100 of the invention by a sequence of flowchart 2000.

In order to save its limited energy, the transaction card 100 is programmed by default to be in a “switched off mode”, waiting for initial keypad entry 2001.

Once a keypad entry (a key is pressed) is detected in step 2001 the PSU switches on the keypad 108 in step 2011, and waits for the PIN code typing in step 2012. In step 2013 the PIN entered is verified, and if found valid the CPU 103 will switch on in step 2020 the enable unit which is part of the CPU 103, and the CVV generator 714, and will simultaneously generate the new CVV code in step 2027, while opening 2021 the 7816 connector's data gate 201 and sending a command to display 2026 the new CVV code on the CVV display 109. Then the user will be able to provide the generated CVV to continue with the payment process in step 2025. Alternatively, the generated CVV can be communicated to the NPC remote payment in step 2006 via telephone or internet. In step 2023 the CPU 103 will switch off the PSU 705 and will transition to a sleep mode in step 2024 while waiting for the next transaction.

### The CVV Generating Unit

The CVV generator unit 714 is an independent module of the main software, which is installed in the CPU 103 ROM unit. During the identification of the user 2013 the Enable Unit, which is part of the CPU 103, will switch on 2020 the CVV generator 714 which displays 2026 the new CVV code at the card LCD display 109.

The CVV generator unit 714 is part of the transaction card 100 operation system software, it generates a new CVV code, based on time windows (for example, the number 1530 can be used for generating the CVV code between 15:30:00 and ten seconds later 15:30:10 (GMT)) which the CPU 103 obtains from a coupled RTC (Real Time Clock)—part of CPU main electronic hardware board.

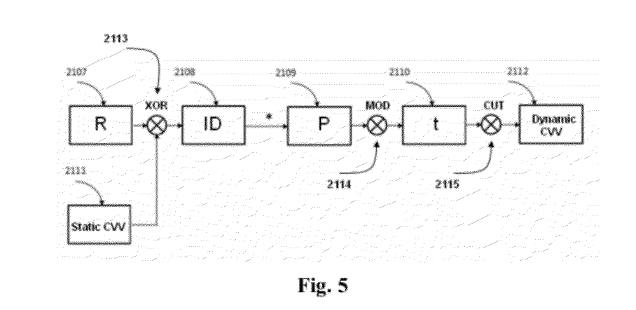

Reference is now made to FIG. 5 which illustrates the CVV generator diagram. During the card manufacturing, a random number (such a number can be a four digit number such as 9467) denoted the Private Key—marked: “R” 2107 is installed in the CPU's 103 memory. In order to avoid a huge random number database and to facilitate a stand alone system without any dependency or external server communication, one can use the static CVV number as the Private Key 2111. Such a code is calculated from the card number and does not require an external database. The XOR gate 2113 will enable to choose the private key 2109 used and then we will multiply the private key with the card ID 2108—the embossed numbers 230 on the front side 200 of the card 100. The result will be multiplied with the Pubic Key—a huge prime number marked: “P”, the result will be we modulated 2114 with a unique formula related to the time segment (see appendix A), marked: “t”, which is synchronized with the clearing machine or the clearing software, for example, while the card switches on in step 2011 of FIG. 4 in order to obtain the CVV code for a new transaction, the CPU's 103 RTC loads a new time segment for the new transaction, as it was programmed, for example, 10 minute from the real time. The card operation system then generates a number composed from the time and the time segment using some arithmetic operation (see appendix A). The composed number is then used for the modulation operation with the public key at the junction 2114. Then from the huge number 12 binary digits will be cut 2115 in some point of the number. The precise location can be synchronized with the time segment. For example, if the first 10 minute of the real time will be the time operation the system will cut the (10+2) MSB (Most Significant Bits) binary bits of the number etc. The 12 digits binary number will be translated to a 3 decimal digits that will compose the new dynamic CVV code 2112 for the present time segment.

The same operation that takes place at the transaction card 100 is also performed at the clearing machine or software. Thus the clearing software in a remote payment CNP scenario or the vendor at the clearing machine can calculate the exact new dynamic CVV code and authenticate the one received from the card 100 when it matches the one calculated at the clearing house. This comparison can be achieved without a dependency on an external server or a huge database.

APPENDIX A
Example 1
r = 2875;
id = 53261003187659871;
t = 1340;
p = 650001127;
x = r * id * t * p
133372440854191432045903961992500
l = IntegerDigits[x]
{1,3,3,3,7,2,4,4,0,8,5,4,1,9,1,4,3,2,0,4,5,9,0,3,9,6,1,9,9,2,5,0,0}
DynamicCVV = Take[1,{7,10}]
{4,4,0,8}
Example 2
r = 5875;
id = 53262323187659871;
t = 0900;
p = 3299251259;
x = r * id * t * p
929150097885577233567539626837500
l = IntegerDigits[x]
{9,2,9,1,5,0,0,9,7,8,8,5,5,7,7,2,3,3,5,6,7,5,3,9,6,2,6,8,3,7,5,0,0}
DynamicCVV = Take[1,{11,14}]
{8,5,5,7}

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, materials or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A transaction card, comprising:
(i) an identifying number associated with the transaction card;
(ii) a real-time clock;
(iii) a screen; and
(iv) a Card Verification Value (CVV) generator unit that based on said identifying number and based on the time reading of said real-time clock, produces a CVV code, said CVV code being displayed on said screen.

2. A transaction card according to claim 1, wherein said identifying number is unique for each transaction card.

3. A transaction card according to claim 1, wherein said identifying number is a random number.

4. A transaction card according to claim 1, wherein a newly generated CVV code is only valid for a single transaction.

5. A transaction card according to claim 1, wherein a newly generated CVV code is only valid for a limited, predefined amount of time after the CVV code has been generated.

6. A transaction card according to claim 1, wherein the CVV generator produces a CVV code by multiplying the identifying number by a number related to the time read from the real-time clock and by a big random number as to obtain a very large number, wherein certain predefined bits are extracted from said very large number in order to form a CVV code.

7. A transaction card according to claim 6 wherein said predefined bits are extracted for the Least Significant Bits (LSB).

8. A transaction card according to claim 1, further comprising an authentication unit that authenticates the transaction card holder by requesting and authenticating a PIN code, said PIN code being entered via a keyboard, a keypad, voice recognition identification, biometric identification, identification via a connection to a remote device or any combination thereof.

9. A transaction card according to claim 8, wherein a communication channel defined by International Organization for Standardization (ISO) 7816 is disabled until said authentication unit authenticates the transaction card holder.

10. A transaction card according to claim 9, wherein disabling the 7816 communication channel is achieved by using the Mosfet gate to enable and disable the power pin of the 7816 connector.

11. A transaction card according to claim 1, wherein a newly generated CVV code is valid for a single transaction or for a limited period of time or both.
